(19) United States
(12) Patent Application Publication
(10) Pub. No.: US 2003/0115443 A1
(43) Pub. Date: Jun. 19, 2003

(54) Multi-O/S system and pre-O/S boot technique for partitioning resources and loading multiple operating systems thereon

(76) Inventors: Darren J. Cepulis, The Woodlands, TX (US); Dave Collins, Magnolia, TX (US)

Correspondence Address: Tait R. Swanson, Fletcher, Yoder & Van Someren, P.O. Box 692289, Houston, TX, 77269-2289, US

(21) Appl. No.: 10/023,680

(22) Filed: Dec. 18, 2001

(51) Int. Cl. G06F 15/177

(52) U.S. Cl. 713/2

(57) ABSTRACT

A technique is provided for loading a multiple-O/S platform on a computing device, such as a personal computer or server. The technique supports multiple operating systems by partitioning the computing device in an initialization or pre-boot phase, in which system resources are detected, initialized and tabulated. A desired O/S of the multiple operating systems is then loaded on each partitioned set of the system resources. The multiple operating systems may then operate simultaneously and independently on the computing device.

### FIELD OF THE INVENTION

The present technique relates generally to the field of computer systems and, more specifically, to operating systems or application platforms. The present technique provides a multi-platform operating environment by identifying computing resources, dividing those resources into multiple resource sets, and loading operating systems on each of those resource sets.

### BACKGROUND OF THE INVENTION

Computer systems generally include a computer housing having a processor, memory and various circuitry. For example, the computer may include a motherboard, a CPU, a hard drive, random access memory (RAM), a disk drive (e.g., a floppy drive, a CD-ROM drive, a DVD-ROM drive, a tape drive, etc.), communication ports, a cooling system (e.g., a fan), a power supply, communication devices (e.g., a modem or network device), an audio assembly (e.g., a sound card, a speaker, etc.), a display, peripheral devices (e.g., a printer, a scanner, a camera, etc.) and various other devices. Computer systems also have a variety of firmware, drivers, handlers, protocols, input/output modules, and software, including an operating system such as Windows, Mac O/S, or LINUX. The operating system generally provides a platform for applications, such as word processors, spreadsheets, databases, graphics programs, Internet programs, and other desired applications. In some situations, specific operating systems are particularly well-suited or required for loading and operating a desired application. In a network environment, a variety of servers and operating systems may be required to run all of the desired applications, such as security applications, addressing and routing applications, content applications, and other network applications.

Accordingly, a technique is needed for consolidating the desired applications onto fewer computing devices, such as servers. More particularly, there is a need for a multi-platform operating system to facilitate the foregoing application consolidation. It would be particularly advantageous to provide a pre-boot partitioning technique, which could partition the resources of the computing device for a plurality of operating systems.

### SUMMARY OF THE INVENTION

A technique is provided for loading a multiple-O/S platform on a computing device, such as a personal computer or server. The technique supports multiple operating systems by partitioning the computing device in an initialization or pre-boot phase, in which system resources are detected, initialized and tabulated. A desired O/S of the multiple operating systems is then loaded on each partitioned set of the system resources. The multiple operating systems may then operate simultaneously and independently on the computing device.

In one aspect, the present technique provides a method for operating a computing device. The method comprises allocating resources of the computing device to a plurality of resource sets prior to loading a desired O/S layer for the computing device. The method also comprises loading a desired operating system on each set of the plurality of resource sets at the desired O/S layer.

In another aspect, the present technique provides a system for booting a computing device. The system comprises a resource tabulator module, a resource divider module, and an operating system loader module. The resource tabulator module is configured to organize data on system resources for the computing device. The resource divider module is configured to create multiple resource sets for the computing device. The operating system loader module is configured to load a desired operating system on each of the multiple resource sets.

### BRIEF DESCRIPTION OF THE DRAWINGS

The invention will hereafter be described with reference to the accompanying drawings, wherein like reference numerals denote like elements, and:

FIG. 1 is a diagram of an exemplary multi-platform operating system of the present technique;

FIG. 2 is a flow chart illustrating an exemplary process for loading and operating the multi-platform operating system of FIG. 1;

FIG. 3 is a diagram illustrating an exemplary resource partition of the present technique;

FIG. 4 is a diagram illustrating an exemplary memory map of resources disposed on multiple memory partitions;

FIG. 5 is a diagram illustrating exemplary resource controller using filters and a semaphore; and

FIG. 6 is a diagram illustrating an exemplary resource controller using a PCI bus, an ACPI-SAPIC message conversion, extended APIC identifiers (EID), and local identifiers (ID).

### DETAILED DESCRIPTION OF SPECIFIC EMBODIMENTS

As described in detail below, the present technique provides a unique system 10 for operating a plurality of platforms, or operating systems, on a computing device. The present technique may be utilized in desktop computers, portable computers (e.g., laptops, notebooks, palmtops, etc.), servers, workstations, and various other electronics and computing devices. In particular, the present technique is useful for server applications, which often require various operating systems to run the desired applications. The present technique advantageously loads multiple operating systems or platforms on the desired computing device in a pre-boot stage (e.g., a ROM-based or BIOS environment), such that the multiple operating systems are all loaded onto the computing device at the same level without an underlying operating system (e.g., Windows, LINUX, or a MAC O/S). Accordingly, the system 10 interfaces with the resources of the computing device, partitions the resources, and loads the multiple operating systems on the partitions for simultaneous and independent operation on the computing device.

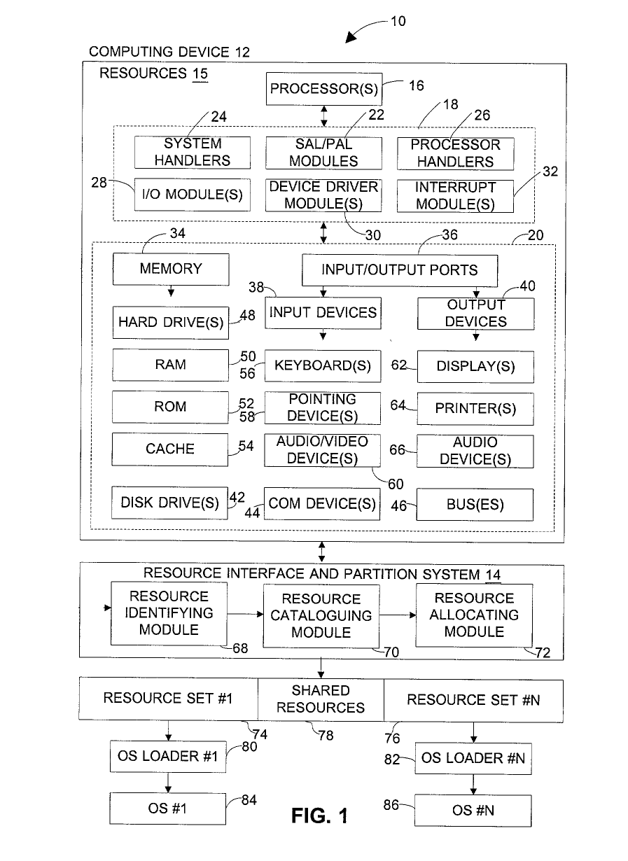

As illustrated in FIG. 1, the system 10 comprises a computing device 12 and a resource interface and partition system 14, which is configured to interface with resources 15 of the computing device 12 and partition the resources 15 into distinct resource sets to support a plurality of independent operating systems on the computing device 12. Although specific examples are provided below, the computing device 12 of the present technique may comprise any suitable hardware and software resources 15 for the desired application. The resources 15 may include a variety of hardware and software, such as one or more circuit boards, one or more processors 16, a variety of system and processor control modules 18, and a plurality of supporting components 20.

For example, the system and processor control modules 18 may include SAL/PAL modules 22 (i.e., system abstraction layer/processor abstraction layer modules), system handlers 24, processor handlers 26, input/output modules 28, device driver modules 30, and interrupt modules 32. The system and processor handlers 24 and 26 may comprise platform runtime services, error handlers, reset handlers, initialization handlers, PMI handlers, and various other desired handlers and control modules. The input/output modules 28 can include a variety of input/output handlers and control routines for the resources 15. For example, a BIOS module, a flash BIOS module, or a plug and play BIOS module can be incorporated into a ROM module, a flash memory module, or any other desired memory module. The device driver modules 30 may comprise software drivers, firmware, and various other device initialization and control modules for the hardware of the computing device 12.

The supporting components 20 may comprise memory 34, input/output ports 36 for a variety of input devices 38 and output devices 40, disk drives 42, communication devices 44, and buses 46. The memory devices 34 can include a variety of memory types and structures, such as one or more hard drives 48, RAM modules 50, ROM modules 52, and cache memory 54. The input devices 38 may comprise one or more keyboards 56, pointing devices 58 (e.g., a mouse, a touch pad, a rollerball, a joystick, etc.), and audio/video devices 60 (e.g., a camera, a scanner, a microphone, etc.). The output devices 40 can include one or more display devices 62 (e.g., a monitor, a flat panel display, an LCD, etc.), printers 64, and audio devices 66 (e.g., speakers). The disk drives 42 may comprise a floppy disk drive, a CD drive, a DVD drive, a tape drive, or any other suitable drive for a read-only or read-and-write media. The communication devices 44 may include a variety of line-based or wireless technologies, such as a modem, a DSL device, an Ethernet device, or any other suitable communication device. For example, the wireless technologies may comprise radio frequency technologies, optical/digital technologies, blue tooth technologies, and various other wireless communication technologies. The buses 46 may embody a variety of architectures, such as a PCI bus, a USB bus, an EISA bus, or any other suitable bus architecture.

As mentioned above, the resource interface and partition system 14 utilizes a variety of hardware and software to interface with, and partition, the foregoing resources 15 into distinct resource sets, each of which supports an independent platform on the computing device 12. The system 10 performs these functions in a pre-boot or initialization phase, such as in a ROM-based or BIOS environment of the computing device 12. Accordingly, the resource interface and partition system 14 may be incorporated into one or more memory modules, such as ROM or Flash memory modules, which run during the pre-boot phase of the system 10. For example, the resource interface and partition system 14 may comprise a resource identifying module 68, a resource cataloguing module 70, a resource allocating module 72, and any other desired modules to facilitate division of the resources 15 (e.g., an extensive firmware interface) prior to an O/S boot on the computing device 12.

In an exemplary embodiment of the present technique, the resource identifying module 68 identifies the resources detected and initialized by the system ROM POST code and passes them to the resource cataloguing module 70, which then organizes the identified resources 15 into one or more lists, tables, databases, or other catalogs. For example, the resource identifying module 68 may retrieve resource tables from the ROM-based or BIOS environment (e.g., from a firmware or BIOS module), and then pass the resource tables to the resource cataloguing module 70 for use in organizing and allocating the resources. The cataloguing module 70 may then create one or more master tables and sub tables based on the resource tables retrieved from the system memory. Alternatively, the resource identifying module 68 may detect and initialize the resources 15, such as by initiating a firmware or BIOS module for the computing device 12. The foregoing firmware or BIOS modules may be disposed on a chip or memory unit, such as nonvolatile memory unit (e.g., ROM, EEPROM, flash memory, NVRAM), which is initiated on power-up of the system. The resource identifying module 68 also may include a diagnostic module, which performs a variety of diagnostics on the resources 15 to ensure reliable operation of the system 10.

The resource allocating module 72 then proceeds to allocate the resources 15 into a plurality of resource sets, which may share some of the resources between the resource sets. The resource allocating module 72 may comprise a resource divider module, a resource sharing module, a resource cloning module, and various other modules to facilitate exclusive and shared access and control of the resources 15. For example, the resource divider module can include a memory partitioning module, a processor partitioning module, and other partitioning modules for creating independent computing clusters from the resources 15. The resource sharing module provides shared control of certain necessary or critical resources 15, such as multi-device driver modules (e.g., a multi-display driver), SAL services, PAL services, input/output services, interrupt services, boot services, runtime services, and various other system and processor services (e.g., modules 18). The resource cloning module also facilitates sharing by generating and distributing instances of at least part of the resources 15, such as boot service modules, runtime service modules, and O/S loader modules.

For example, the system 10 may allocate the resources 15 into a plurality of resource sets, such as resource sets 74 and 76 (i.e., Resource Sets #1 and #2), which may comprise a variety of shared resources 78. Each of the resource sets 74 and 76 can include a portion of the processors 16 (e.g., a CPU cluster), a portion of the memory 34, a portion of the input/output ports 36 and corresponding input devices 38 and output devices 40, one or more of the disk drives 42, and various other portions of the resources 15. The resource sets 74 and 76 also may include all or part of the system and processor control modules 18, such as boot services and runtime environment descriptors (e.g., ACPI and SST tables). The system 10 also may utilize USB architecture to obviate the need for common device drivers, such as a common keyboard driver. As discussed above, the shared resources 78 may comprise a variety of hardware and software, such as the input/output modules 28, the interrupt modules 32, the SAL/PAL modules 22, a dual screen video driver, and various other resources.

Although the resource allocating module 72 may be configured for automatic allocation of the resources 15, the system 10 may include a user interface for allocating the resources 15 manually or interactively. For example, the user may browse the resources 15 identified and catalogued by the modules 68 and 70, select a desired number of resource sets, and allocate the resources into each of the resource sets. The user interface also may provide partitioning/allocating recommendations, limitations on the allocations (e.g., each resource set must have a certain amount of processor and memory resources), automatic sharing of critical or necessary resources, and various other features to facilitate a workable partition of the resources 15. For example, the resources 15 may be partitioned based on the resource requirements of the desired operating systems, the desired applications for each of the operating systems, the desired operational environment (i.e., a network/server environment), and various other factors. These factors may be accounted for automatically by the resource allocating module 72, or the user may tailor the resource allocation manually via the user interface.

The system 10 may then configure multiple independent operating systems based on the multiple resource sets (e.g., resource sets 74 and 76). For example, the system may allocate operating system loaders 80 and 82 (i.e., O/S Loaders #1 and #2) to the resource sets 74 and 76 (i.e., Resource Sets #1 and #2) to load operating systems 84 and 86 (i.e., OS's #1 and #2), which may embody identical or different operating systems or platforms. For example, if the user desires an identical operating system on each of the multiple resource sets, then the resources 15 may initially include a single stored copy of the desired operating system and the corresponding loader module. The resource interface and partition system 14 can then duplicate this single stored copy during resource allocation to provide multiple instances for the multiple resource sets. Alternatively, the system 10 may load the multiple operating systems via a media, such as a CD, a DVD, a floppy disk, or a remote server drive. In either case, the operating system loading may proceed automatically or manually via user interaction, simultaneously or sequentially on each of the resource sets, and with the desired defaults or custom configurations.

A variety of applications also may be loaded and independently run on these operating systems 84 and 86. For example, the operating system 84 may embody a LINUX operating system that is particularly well-suited for a first network application, whereas the operating system 86 may embody a Windows or Mac operating system that is particularly well-suited for a second network application. The operating systems 84 and 86, and corresponding applications, can then run on the computing device 12 using the respective resource sets 74 and 76. Accordingly, the system 10 comprises an initialization layer to detect, initialize and partition the resources 15 in support of the multiple operating systems, an operating system layer comprising the multiple operating systems on each of the partitions, and an applications layer comprising independent sets of applications on each of the partitions/operating systems.

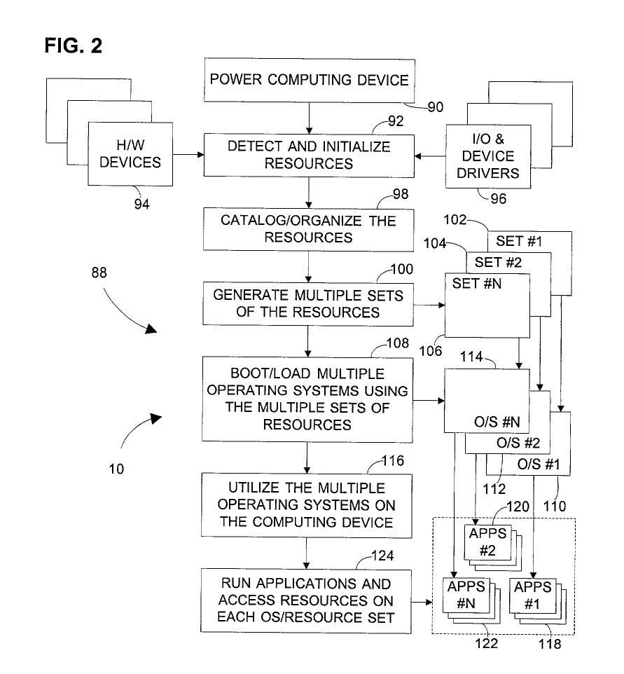

As described above, and illustrated by process 88 of FIG. 2, the multi-platform system 10 is configured and operated by partitioning the resources 15 during a pre-boot phase of the computing device 12, and then loading multiple operating systems on the respective resource sets. For example, the process 88 may proceed by powering the computing device (block 90) into a pre-boot or initialization phase, wherein the process 88 detects and initializes resources 15 of the computing device (block 92). As described above, the process 88 may configure the resources 15 automatically or manually via a ROM-BIOS module or any other suitable configuration module, which may be disposed on ROM, RAM, EEPROM, Flash Memory, a floppy disk, a remote network drive, or any other suitable storage device. For example, the pre-boot or initialization phase may configure the basic hardware devices of the computing device. This generally occurs prior to booting the primary operating system (e.g., Windows, LINUX, MAC O/S, etc.), which supports the desired applications software for the computing device. During this pre-boot phase, the process 88 may execute the input/output modules 28, the device driver modules 30, and various other system and processor control modules 18. Accordingly, the process 88 detects the hardware devices 94 and executes the input/output and device drivers 96 to facilitate interaction with the resources 15 during the subsequent stages of configuring and loading multiple operating systems.

The process 88 then catalogs and organizes the resources (block 98). For example, the resources may be tabulated into one or more resource tables, such as a hardware table, a memory resource table, a processor resource table, or any other desired table. In an exemplary embodiment of the present technique, the process 88 obtains resource tables from a ROM-BIOS module, a firmware module, or another device initialization module. The process 88 then generates multiple sets of the resources (block 100), such as resource sets 102, 104 and 106 (i.e., sets #1, #2 and #N), which may include exclusive and shared portions of the resources 15. As discussed above, the process 88 may generate these resource sets automatically or manually via a user interface.

The foregoing resource sets 102, 104 and 106 then support a plurality of independent application platforms or operating systems, which are simultaneously and independently operable on the computing device 12. For example, the process 88 may boot or load multiple operating systems, such as operating systems 110, 112 and 114 (i.e., O/S's #1, O/S #2 and O/S #N), on the multiple sets of resources (block 108). The operating systems 110, 112 and 114 may comprise identical or different operating systems, such as Windows, LINUX, and a MAC O/S, each of which may be utilized independently on the computing device 12 via the resource sets 102, 104 and 106 (block 116). The process 88 can then load and run the desired applications, such as software applications 118, 120 and 122 (i.e., APPS #1, #2 and #N), on each of the operating systems 110, 112 and 114 (i.e., O/S's #1, #2 and #N), respectively (block 124). As the user utilizes the operating systems 110, 112 and 114 and the corresponding applications 118, 120 and 122, the respective resource sets 102, 104 and 106 provide exclusive and shared access, use and control of the hardware and software components within those resource sets 102, 104 and 106 (Block 124).

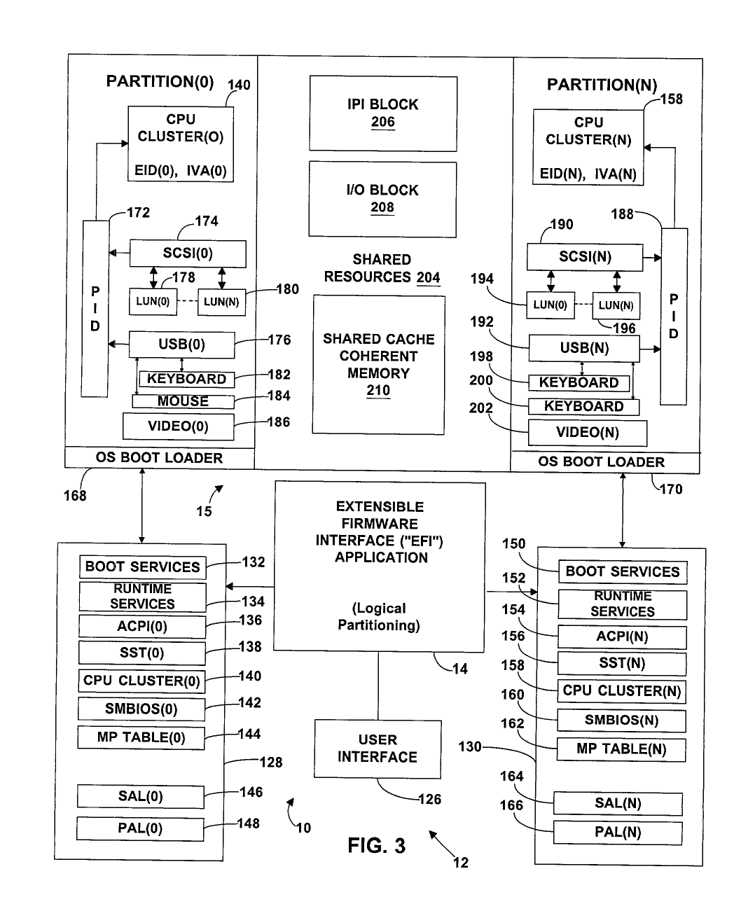

FIG. 3 illustrates an exemplary embodiment of the system 10, wherein the resources 15 are partitioned for simultaneously running multiple operating systems. As illustrated, the system 10 utilizes the interface 14 to partition the resources 15 and initiate loading of multiple operating systems. In this exemplary embodiment, the interface 14 embodies an extensible firmware interface (“EFI”) for logical partitioning by using information obtained from the BIOS, ACPI tables, SST tables, MP tables, etc. The system also provides a user interface 126 for interacting with the extensible firmware interface 14 to facilitate partitioning of the resources 15. In operation, the interface 14 spawns multiple instances of native EFI boot services and run-time environment descriptors (e.g., a CPI, SST, and MP tables), such as illustrated by resource groups 128 and 130, which correspond to the multiple partitions. As illustrated, the resource groups 128 and 130 correspond to partitions “0” and “N,” which may be any desired number of partitions and operating systems for the computing device 12. In FIG. 3, only two such partitions are provided for illustration purposes.

Resource group 128 may comprise a variety of system and processor resources, such as boot services 132, run-time services 134, ACPI(0) tables 136, SST(0) tables 138, CPU clusters(0) 140, SMBIOS(0) data 142, MP tables(0) 144, system abstraction layer SAL(0) 146, and processor abstraction layer PAL(0) 148. Similarly, resource group 130 may comprise a variety of system and processor resources, such as boot services 150, run-time services 152, ACPI(N) tables 154 to, SST(N) tables 156, CPU clusters(N) 158, SMBIOS(N) data 160, MP tables(N) 162, system abstraction layer SAL(N) 164, and processor abstraction layer PAL(N) 166. The extensible firmware interface 14 creates the foregoing resource groups 128 and 130 independent of the particular BIOS disposed on the computing device 12.

The extensible firmware interface 14 then proceeds to initiate boot loaders for each of the desired operating system, which may be loaded and simultaneously operated on the computing device 12. Accordingly, an OS boot loader 168 is initiated for partition “0,” while an OS boot loader 170 is initiated for partition “N.” These OS boot loaders 168 and 170 load desired operating system, such as Windows, Linux, MacOS or any other suitable operating system, onto the respective partitions “0” and “N.” The respective operating systems may be the same or different, as desired for particular applications.

As illustrated, partition “0” comprises the CPU clusters(0) 140, which are distinguished by an extended APIC identifier EID(0) and an interrupt vector address IVA(0). The partition “0” also comprises an interrupt controller 172 (e.g., a peripheral interrupt device) and various other device controllers and components. The interrupt controller 172 may be coupled to a SCSI(0) controller 174, a USB(0) controller 176, and any other suitable controllers for controlling various hardware devices. For example, the SCSI(0) controller 174 may be coupled to drives LUN(0) 178 and LUN(N) 180, which may embody hard disk drives, floppy disk drives, CD-ROM drives, or a variety of other hardware components. Similarly, the USB(0) controller 176 may be coupled to the keyboard 182, a mouse 184, and any other desired input/output devices. The partition “0” also may include a video controller 186 and any other suitable hardware and software resources, as described above with reference to FIGS. 1 and 2.

The remaining partitions also may comprise a variety of hardware and software resources. For example, partition “N” comprises the CPU clusters(N) 158, which are distinguished by an extended APIC identifier EID(N) and an interrupt vector address IVA(N). The partition “N” also comprises an interrupt controller 188 (e.g., a peripheral interrupt device) and various other device controllers and components. For example, the interrupt controller 188 may be coupled to a SCSI(N) controller 190, a USB(N) controller 192, and various other controllers for controlling various hardware devices. For example, the SCSI(N) controller 190 may be coupled to drives LUN(0) 194 and LUN(N) 196, which may embody hard disk drives, floppy disk drives, CD-ROM drives, or a variety of other hardware components. Similarly, the USB(N) controller 192 may be coupled to a keyboard 198, a mouse 200, any other desired input/output devices. The partition “N” also may include a video controller 202 and any other suitable hardware and software resources, as described above with reference to FIGS. 1 and 2. Also note that some of the foregoing hardware resources, such as the keyboard and mouse, may be shared between the multiple partitions and operating systems.

As discussed in detail above, the partitioning system of the present technique also may share a variety of hardware and software resources, such as illustrated by the shared resource group 204. In this exemplary embodiment, the plurality of operating systems and partitions “0” through “N” share an IPI block 206, an I/O block 208, and shared cache coherent memory 2 10. These shared resources facilitate operation of the multiple operating systems on the multiple partitions and facilitate intercommunication between the various partitions and shared resources of the computing device 12. Accordingly, the operating systems have no fixed memory dependencies (i.e., “zero-based memory” independent). The foregoing resources also may be dynamically assigned and reassigned during operation of the multiple operating systems. The multiple operating systems communicate with one another to facilitate this dynamic use of the resources 15 and by utilizing hot plug drivers, interrupt controllers, filters and semaphores, dynamic reallocation modules, various resource identifiers, and various other communication and allocation modules. For example, the present technique may use memory hot plug drivers to dynamically allocate/de-allocate memory resources between partitions, and CPU hot plug drivers to dynamically allocate/de-allocate processing resources between partitions. Accordingly, once the multiple operating systems are loaded on the multiple resource partitions, the shared and partition resources can be dynamically reallocated as needed by each of the respective operating systems.

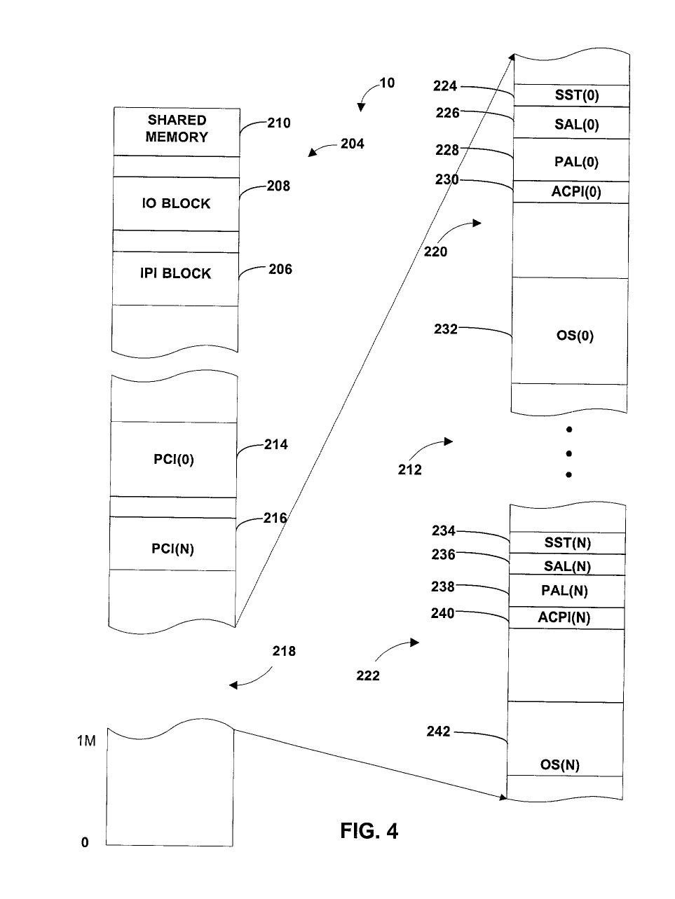

FIG. 4 illustrates an exemplary memory map 212 of the system 10 generated by the unique partitioning techniques described above. As illustrated, the resources 15 may comprise shared resources 204, such as the shared memory 210, the I/O block 208 and the IPI block 206. The resources 15 also may comprise variety of software, buses, controllers, software and hardware devices, such as PCI(0) 214 and PCI(N) 216. The system 10 partitions physical memory resources 218, such as RAM and hard disk drives, and maps the remaining partitioned resources onto each of the physical memory partitions. For example, as illustrated in FIG. 4, the system 10 maps the remaining partitioned resources to memory partitions 220 and 222. The memory partition 220 comprises a variety of resources, such as SST(0) tables 224, system abstraction layer SAL(0) 226, processor abstraction layer PAL(0) 228, ACPI(0) tables 230 and operating system OS(0) 232. The memory partition 222 also comprises a variety of resources, such as SST(N) tables 234, system abstraction layer SAL(N) 236, processor abstraction layer PAL(N) 238, ACPI(N) tables 240, and operating system OS(N) 242. Although specific resources are illustrated in FIG. 4, any other desired resources may be shared or partitioned according to the memory map 212.

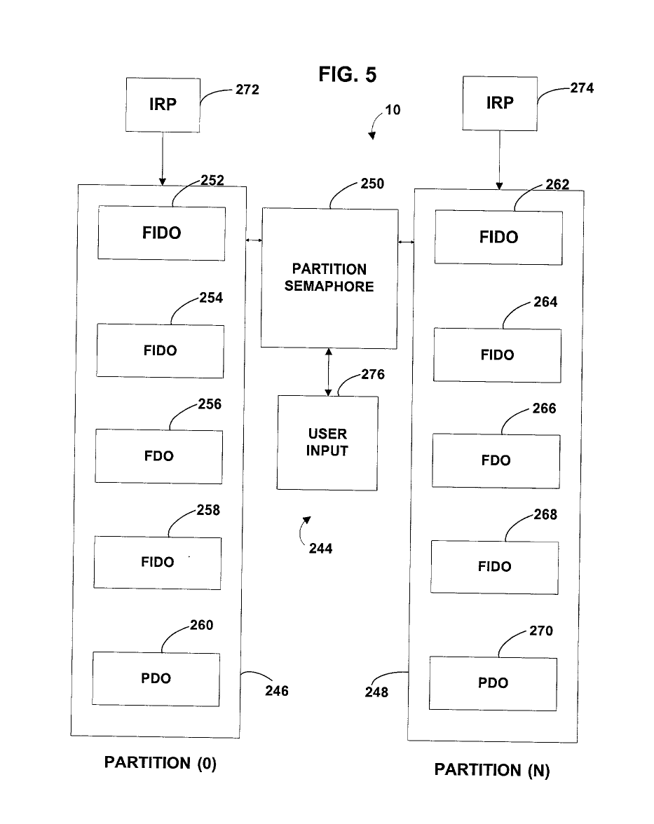

FIG. 5 is a diagram illustrating an exemplary resource controller 244 of the system 10 for implementing certain aspects of the unique partitioning scheme described above. The resources 15 of the computing device 12 are partitioned into a plurality of partitions, such as partition (0) 246 and partition (N) 248. In operation, the operating systems disposed on each of the plurality of partitions may request certain resources to perform an operation. The resource controller 244 runs on the various partitions to share the resources 15 (except, possibly not for physical memory and processors). The resource controller 244 comprises filters on each of the partitions to receive input/output requests and a partition semaphore 250 to evaluate and direct the input/output requests to the appropriate partition. For example, partition 246 comprises a filter 252 and a variety of other drivers and filters, such as indicated by reference numerals 254, 256, 258 and 260 (e.g., OS drivers and filters). Similarly, the partition 248 comprises a filter 262 and a variety of other drivers and filters, such as indicated by reference numerals 264, 266, 268, and 270 (e.g., OS drivers and filter). As input/output requests 272 and 274 are received by filters 252 and 262, the partition semaphore 250 evaluates the request, determines the status of the requested resource, and proceeds to direct each of the input/output requests to the appropriate partitions. Moreover, the user may control or interact with the partition semaphore 250 via a user interface or other user input, such as user input 276 (e.g., a key stroke, such as a control key). Accordingly, the resource controller 244 allows the various partitions to share resources, such as a floppy disk drive, a CD-ROM drive, a keyboard, a mouse, a monitor, and various other input output devices.

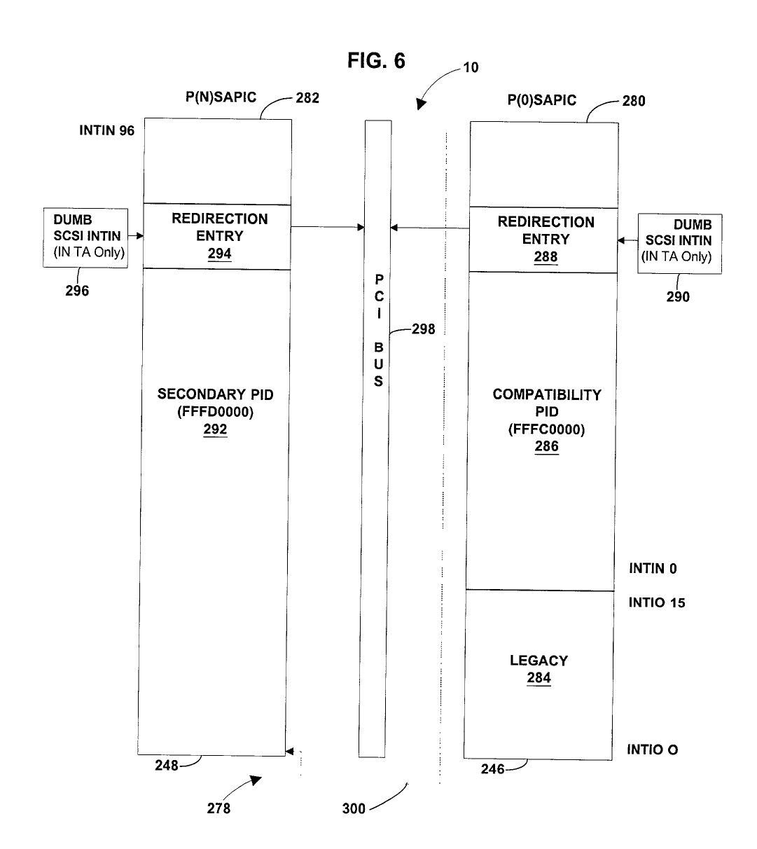

FIG. 6 is a diagram illustrating an exemplary resource controller 278 of the system 10 for controlling resource messages, such as interrupt messages. As illustrated, the resource controller 278 comprises interrupt controllers P(0)SAPIC 280 and P(N)SAPIC 282 disposed on each respective partition 246 and 248, respectively. The interrupt controller 280 comprises a legacy system 284, a compatibility peripheral interrupt device (“PID”) 286 having an address FFFC0000, and a redirection entry 288, which is coupled to a device controller 290 (e.g., a dumb SCSI controller). The interrupt controller 282 comprises a secondary peripheral interrupt device (“PID”) 292 and a redirection entry 294, which is coupled to a device controller 296 (e.g., a dumb SCSI controller).

The interrupt controllers 280 and 282 communicate through a PCI bus 298 via the redirection entries 288 and 294 (i.e., redirection registers), which comprise interrupt registers, extended APIC identifiers (EID's) for identifying the domain, and internal identifiers (ID's) for identifying the processor within the domain. Conventional systems use a proprietary APIC serial-type bus for interrupt control and APIC messaging. Instead, the resource controller 278 of the present technique detects and delivers messages to the various processors via the PCI bus 298. The redirection entries, such as the redirection entry 288, convert ACPI messages to SAPIC messages and deliver the converted messages to the appropriate processor. Also note that the P(N)ACPI SAPIC entry includes a legacy entries, but does not include P(0)PCI entries. In this exemplary embodiment, the interrupt controllers 280 and 282 are disposed in adjacent memory, as indicated by arrow 300. Accordingly, the foregoing ACPI—SAPIC partitioning control scheme facilitates resource allocation, control and sharing among the various resource partitions of the present technique.

While the invention may be susceptible to various modifications and alternative forms, specific embodiments have been shown by way of example in the drawings and have been described in detail herein. However, it should be understood that the invention is not intended to be limited to the particular forms disclosed. For example, the present technique may be applied to a variety of computing systems, computing components, and other electronic and computing devices. Accordingly, the invention is intended to cover all modifications, equivalents, and alternatives falling within the spirit and scope of the invention as defined by the following appended claims.

What is claimed is:

1. A method for operating a computing device, comprising:
allocating resources of the computing device to a plurality of resource sets prior to loading a desired O/S layer for the computing device; and
loading a desired operating system on each set of the plurality of resource sets at the desired O/S layer.

2. The method of claim 1, wherein allocating resources comprises organizing the resources in a ROM-based environment.

3. The method of claim 2, wherein organizing the resources in the ROM-based environment comprises gathering device data from a BIOS module.

4. The method of claim 1, wherein allocating resources comprises dividing the resources in an initialization phase of the computing device.

5. The method of claim 4, wherein allocating resources comprises sharing at least a portion of the resources.

6. The method of claim 1, wherein allocating resources comprises identifying and initializing at least a portion of the resources.

7. The method of claim 1, wherein allocating comprises manually selecting desired allocations of the resources via a user interface.

8. The method of claim 1, comprising running multiple desired operating systems at the desired O/S layer on the computing device.

9. A method for simultaneously supporting a plurality of independent operating systems on a computing device, comprising:
cataloguing resources of the computing devices prior to O/S booting for the computing device;
dividing the resources into multiple subsets prior to O/S booting; and
loading the plurality of independent operating systems, at least one O/S being loaded on each resource set of the multiple subsets.

10. The method of claim 9, wherein the plurality of independent operating systems provide independent platforms for loading and running application software.

11. The method of claim 10, wherein cataloguing, dividing and loading are performed in an initialization phase of the computing device.

12. The method of claim 9, wherein dividing the resources comprises allocating desired portions of hardware and system services to each of the multiple subsets.

13. The method of claim 12, wherein allocating desired portions of hardware and system services comprises sharing the system services between the multiple subsets and the independent operating systems loaded thereon.

14. A system for booting a computing device, comprising:
a resource tabulator module configured to organize data on system resources for the computing device;
a resource divider module configured to create multiple resource sets for the computing device; and
an operating system loader module configured to load a desired operating system on each of the multiple resource sets.

15. The system of claim 14, wherein the resource tabulator module and the resource divider module are disposed in a pre-boot environment.

16. The system of claim 15, wherein the resource tabulator module and the resource divider module are disposed in ROM.

17. The system of claim 14, wherein the pre-boot environment comprises hardware detection modules for the system resources.

18. The system of claim 14, wherein the pre-boot environment comprises hardware driver modules for the system resources.

19. The system of claim 14, wherein the resource divider module comprises a user interface.

20. The system of claim 14, wherein the resource divider module comprises a hardware partitioning module.
